(19) United States
(12) Patent Application Publication
(10) Pub. No.: US 2025/0338083 A1
(43) Pub. Date: Oct. 30, 2025

(54) Terminal, System, and Method for Performing Sidelink Localization Procedure

(71) Applicant: Apple Inc., Cupertino, CA (US)

(72) Inventors: Oghenekome Oteri, San Diego, CA (US); Chunxuan Ye, San Diego, CA (US); Wei Zeng, Saratoga, CA (US); Haitong Sun, Saratoga, CA (US); Chunhai Yao, Beijing (CN); Yushu Zhang, Beijing (CN); Dawei Zhang, Saratoga, CA (US); Seyed Ali Akbar Fakoorian, San Diego, CA (US); Sigen Ye, San Diego, CA (US); Huaning Niu, San Diego, CA (US)

(21) Appl. No.: 18/861,042

(22) PCT Filed: Apr. 29, 2022
(86) PCT No.: PCT/CN2022/090150

§ 371 Date: Oct. 28, 2024

(51) Int. Cl. H04W 4/02; H04W 72/25; H04W 72/30

(52) U.S. Cl. CPC H04W 4/025; H04W 72/25; H04W 72/30

(57) ABSTRACT

A first terminal may include a receiver that receives, from a second terminal, configuration parameters for a Sidelink (SL) localization procedure in which positioning information of the first terminal is obtained. Further, the first terminal may include a processor configured to determine, based on the configuration parameters, reference information and synchronization information to be used in a SL transmission procedure to obtain the positioning information.

### FIELD

The present application relates to wireless devices and wireless networks, including devices, circuits, and methods for performing Sidelink localization procedures.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

According to one or more embodiments, a first terminal includes a receiver that receives, from a second terminal, configuration parameters for a Sidelink (SL) localization procedure in which positioning information of the first terminal is obtained. Further, the first terminal may include a processor configured to determine, based on the configuration parameters, reference information and synchronization information to be used in a SL transmission procedure to obtain the positioning information.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a BS, according to some aspects.

FIG. 4 illustrates an example block diagram of wireless communication circuitry, according to some aspects.

FIG. 5 illustrates an example Sidelink (SL) localization procedure, according to some aspects.

FIGS. 6A to 6D are diagrams illustrating an example SL localization procedure including an SL-Localization Management Function (LMF), according to some aspects.

FIG. 7 is a flowchart detailing a method of performing a SL localization procedure, according to some aspects.

FIGS. 8A and 8B are diagrams illustrating a first example SL localization procedure including a Time Difference of Arrival (TDOA) terminal configuration, according to some aspects.

FIGS. 9A and 9B are diagrams illustrating a second example SL localization procedure including a TDOA configuration, according to some aspects.

FIG. 10 is a flowchart detailing a method of performing a SL localization procedure, according to some aspects.

FIGS. 11A and 11B are diagrams illustrating an example SL localization procedure including an Angle of Arrival (AoA) terminal configuration, according to some aspects.

FIGS. 11C and 11D are diagrams illustrating an example SL localization procedure including an Angle of Departure (AoD) terminal configuration, according to some aspects.

FIG. 12 is a flowchart detailing a method of performing a SL localization procedure, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study and evaluate the performance and feasibility of potential solutions for sidelink (SL) positioning in 5G/New Radio (NR), considering relative positioning, ranging, and absolute positioning. To enable improved SL positioning, the embodiments disclosed herein will present several solutions, including: 1) a Location Management Function (LMF) for SL-based positioning; 2) a Sidelink Time Difference on Arrival (SL-TDOA) solution (based on either outgoing or incoming SL signals); 3) a solution based on Sidelink Angle of Arrival/Angle of Departure (SL-AoA/AoD) analysis; and 4) Sidelink Group ID measurements (SL-Group ID).

In accordance with one or more embodiments, a user equipment (UE) device or terminal communicating with other terminals (other wireless communication devices, network devices, UE devices, and/or Base Station (BS) devices) may perform radio transmissions including localization procedures to obtain positioning information relating to the UE device. The positioning information may be one or more results from measurement operations specifying a location of the UE device with respect to one or more neighboring terminals with a known location on Earth or within a specific area (in a predetermined or estimated area, such as its location in a section of a building).

In some embodiments, a UE device may be configured to coordinate the localization procedures with other terminals using at least one Sidelink (SL) communication link. The UE device or one of the other terminals may use the established SL communication links to calculate the positioning information of the UE device when the UE device is in an area with reduced coverage, or without coverage, from a core network. To calculate the positioning information, data transmissions from the UE device may be configured with specific resources to obtain the positioning information. The UE device may obtain the positioning information by implementing one of multiple SL localization procedures. These localization procedures may be modified based on an existing coverage on the UE device, ongoing data transmissions among the neighboring terminals, and other sensing and/or communication procedures. In this disclosure, various of these possible SL localization procedures are described in detail.

The UE device may be configured to perform one or more SL transmissions as part of the SL transmission procedure. The one or more SL transmissions may be transmissions following protocols in which the UE device allocates resources for a same reference information and a same synchronization information used across neighboring terminals. In some embodiments, the UE device is configured to use the reference information and the synchronization information to communicate with at least one neighboring terminal. The synchronization information may include communication information relating to allocation of resources for at least one synchronization signal. The terminals involved in an SL localization procedure using the SL transmissions may all share the same synchronization signal. The reference information may include communication information identifying at least one neighboring terminal to the UE device as a positioning reference. The positioning reference may be a neighboring terminal that is configured to obtain its absolute location on Earth or in the specific area. The UE device may implement the SL localization procedure upon receiving instructions from one of its neighboring terminals or upon receiving approval from one of its neighboring terminals after requesting an initialization of the SL localization procedure. The UE device may coordinate the SL transmissions with terminals connected through multiple radio access technologies (RATs) (i.e., LTE-A, 5G NR, and the upcoming 6G).

In some embodiments, the UE device is configured to perform the SL transmissions without negatively impacting a user's experience. To achieve this, the UE device allocates positioning resources without taking data integrity away from communication resources allocated in a same SL transmission. Successful allocation of resources in the SL transmission may prevent data rate reductions, delay increases, or jitter. In this regard, the UE device obtains communication parameters that define the reference information and the synchronization information for the SL localization procedure. The UE device may use the communication parameters to determine a resource allocation pattern to be used in the SL transmission procedure.

In other embodiments, the UE device identifies an SL reference signal that is used in the SL localization procedure to obtain the positioning information based on the configuration parameters. The resource allocation pattern may be determined based on the SL reference signal identified. The resource allocation pattern may include resources allocated to include the SL reference signal. Examples of the SL reference signal may include an SL-Positioning Reference Signal (PRS) configured to be implemented in a first resource allocation pattern, an SL-Positioning Sounding Reference Signal (PSRS) configured to be implemented in a second resource allocation pattern, or an SL-joint PRS/PSRS (P(S)RS) configured to be implemented in the first resource allocation pattern, the second resource allocation pattern, or a combination of the first resource allocation pattern and the second resource allocation pattern based on terminal information of the UE device.

The UE device may initiate the SL localization procedure by transmitting, to the neighboring terminal, a broadcasting signal, which may include terminal capability and at least one communication request. The terminal capability may be communication information regarding one or more transmission and reception capabilities of the UE device, while the communication request may include a request for a start of the localization procedure to the neighboring terminal.

As described above, the configuration parameters may be received by the UE device from the neighboring terminal via an SL communication link. If the neighboring terminal is another UE device, the configuration parameters may be obtained from the other UE device via additional communication links established with a core network. If the neighboring terminal is a base station, the configuration parameters may be obtained from the base station via higher layer signaling (e.g., signaling received from upper layers using Radio Resource Control (RRC) messaging or medium Access Control (MAC) messaging in devices connected to the core network).

In the SL localization procedure, the UE device may attempt to obtain its positional information upon identifying that the UE has exited an area of coverage from the core network (e.g., the UE device is out of coverage). The UE device may obtain the positional information and its absolute location directly from the neighboring terminal. In some embodiments, the UE device may be configured to derive its absolute location from the positional information obtained from the neighboring terminal. In the SL localization procedure between the neighboring terminal and the UE device, the absolute location of the UE device may be derived based on the absolute location to the neighboring terminal and a location of the UE device with respect of the neighboring terminal. Upon obtaining the absolute location of the neighboring terminal, the neighboring terminal or the UE device may determine relative positioning associated with the UE device. In some embodiments, the neighboring terminal or the UE device may determine the location of the UE device with respect to the neighboring terminal after evaluating one or more signals received or transmitted. In turn, the neighboring terminal or the UE device may calculate the absolute location of the UE device based on the relative positioning. In some embodiments, options for the localization procedure include a Location Management Function (LMF) localization procedure, a Time Difference of Arrival (TDOA) localization procedure, an Angle of Arrival (AoA) localization procedure, an Angle of Departure (AoD) localization procedure, or an SL-Group ID localization procedure.

The following is a glossary of terms that may be used in this disclosure:

Memory Medium-Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium-a memory medium as described above, as well as a physical transmission medium, such as a bus, network, and/or other physical transmission medium that conveys signals such as electrical, electromagnetic, or digital signals.

Programmable Hardware Element-includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device-any of various types of computer systems or devices that perform wireless communications. A wireless device may be portable (or mobile) or may be stationary or fixed at a certain location. A UE is an example of a wireless device.

Communication Device-any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

### Example Wireless Communication System

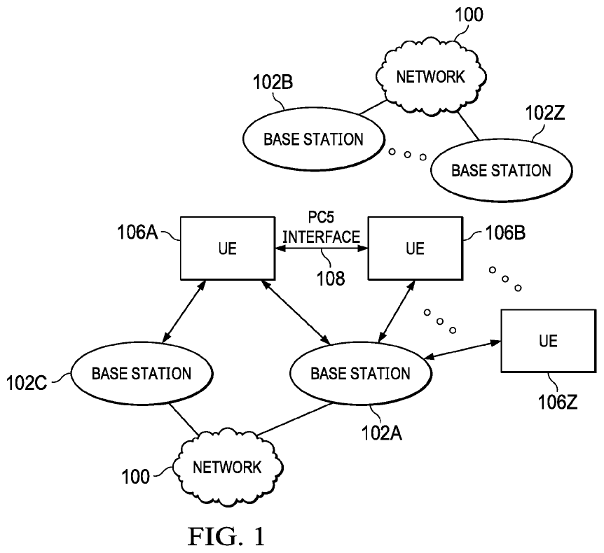

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a PC5 interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via a PC5 interface 108. The PC5 interface 108 may comprise one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHZ Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherproof enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a set of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Description of Sidelink (SL) Communication Links

In one or more embodiments, SL communication links are communication links established between terminals acting as UE devices. In SL communication links, each of the aforementioned physical channels corresponds to a set of resource elements carrying information originating from higher layers. These resource elements may be transmitted via sidelink physical signals used by a physical layer without carrying information originating from higher layers. These physical signals may include reference information signaling and the synchronization information signaling. The reference information signaling may include reference information identifying at least one terminal a positioning reference using a reference signal (e.g., a demodulation reference signal). The positioning reference may be a terminal that is configured to obtain its absolute location on Earth or on the specific area. The synchronization information signaling may include synchronization information relating to allocation of resources for at least one synchronization signal.

The reference signal is used to provide multiple terminals with a baseline transmission information that the terminals may be capable of identifying on transmissions received from each other. As described above, reference signals are predefined signals occupying specific resource elements within a communication time-frequency grid. In the NR specification, multiple types of reference signals may be transmitted in different ways and intended to be used for different purposes by a receiving device. In this disclosure, the reference signals are modified for implementation in SL transmissions.

Examples of synchronization information may include communication information relating to allocation of resources for at least one synchronization signal. A first option for the synchronization signal may be a Demodulation Reference Signal (DMRS) used for the PSSCH. In an Orthogonal Frequency Division Multiplexing (OFDM) symbol for the PSSCH, the synchronization signal may be the associated DMRS. A second option for the synchronization signal may be a DMRS for Demodulation Reference Signal (DMRS) used for the PSSCH. A third option for the synchronization signal may be a Phase Tracking Reference Signal (PTRS) configured to track phase changes and compensate phase noise during SL transmissions, which may be used for higher carrier frequencies. A time density and a frequency of the PTRS may be configured by the upper layers and may be configured per resource pool. A fourth option for the synchronization signal may be a Channel-State Information Reference Signal (CSI-RS). The CSI-RS may be used for channel sounding. The receiving device may measure the received CSI-RS, then may report back the CSI to the transmitter via the PSSCH. The CSI-RS may be configurable in both the time domain and frequency domain. The CSI-RS may be used to provide fine channel state information. A fifth option for the synchronization signal may be a Synchronization Signal (SS)/PSBCH Block. A slot that transmits the SS/PSBCH block may be referred to as a Sidelink Synchronization Signal Block (S-SSB). The SS/PSBCH block may include PSBCH, Sidelink Primary Synchronization Signal (SPSS) and Sidelink Secondary Synchronization Signal (SSSS) symbols. The period of the S-SSB transmission may be 16 frames, and within each period, the number of S-SSB blocks N in the S-SSB period is configured at the RRC. The range of choices for N may vary based on the numerology and the frequency range.

In one or more embodiments, the UE devices are configured to handle simultaneous sidelink and uplink/downlink transmissions. If any of the UE devices include limited reception capabilities in comparison to the rest of the UE devices, this UE device may prioritize sidelink communication reception, sidelink discovery reception on carriers configured by the eNodeB, and last sidelink discovery reception on carriers not configured by the gNB.

Sidelink transmissions may be organized into radio frames with a duration of T_{f}, each consisting of 20 slots of duration Tₛₗₒₜ. A sidelink subframe consists of two consecutive slots, starting with an even-numbered slot. A transmitted physical channel or signaling in a slot may be described by a resource grid corresponding to a first number of subcarriers and a second number of Single-Carrier (SC)-Frequency Division Multiple Access (FDMA) symbols.

In some embodiments, SL transmissions may be configured in accordance with a resource allocation pattern provided by the gNB. The resource allocation pattern may provide dynamic grants of sidelink resources, as well as grants of periodic sidelink resources configured semi-statically by sidelink configured grants. To improve a reliability of the SL transmissions, a dynamic sidelink grant DCI may provide resources for one or multiple transmissions of a transport block. The sidelink configured grants may be SL transmissions configured to be used by the UE device immediately, until these grants are released by RRC signaling. The UE device may be allowed to continue using this type of sidelink configured grants when beam failure or physical layer problems occur in NR access links (Uu) until a Radio Link Failure (RLF) detection timer expires, before falling back to an exception resource pool. Another type of sidelink configured grant may be a grant that is configured once and may not be used until the gNB sends the UE device a DCI indicating that the grant is now active, and until another DCI indicates deactivation.

In the sidelink configured grants, the resources are a set of sidelink resources recurring with a periodicity which the gNB matches resourced to those characterize for V2X traffic. Multiple configured grants can be configured, to allow provision for different services, traffic types, and the like. Modulation and Coding Scheme (MCS) information for dynamic and configured grants may be optionally provided or constrained by the RRC signaling instead of the DCI. The RRC may configure exact MCS the uses, or a range of MCSs. The MCS may also be left unconfigured. For the cases where the RRC does not provide the exact MCS, the UE device may be left to select an appropriate MCS itself based on any knowledge it may have of the transport block to be transmitted and sidelink radio conditions. The gNB scheduling activity may be driven by reporting in which the UE device shares its sidelink traffic characteristics to the gNB, or by performing a sidelink Buffer Status Report (BSR) procedure similar to that of the Uu to request the sidelink resource allocation from the gNB.

In some embodiments, the SL transmissions for the UE device may be configured in accordance with a self-selected resource allocation pattern. The SL transmissions may be transmitted by the UE device a certain number of times after a resource allocation pattern is selected, or until a cause of resource reselection is triggered. The SL transmissions may be performed to support unicast and groupcast communications in the physical layer. The SL transmissions may be configured to reserve resources to be used for a number of blind transmissions or HARQ-feedback-based transmissions of the transport block. The SL transmissions may be performed to select resources to be used for the initial transmission of a later transport block.

In one or more embodiments, the resource allocation patterns selected for the SL transmissions may be implemented in SL Bandwidth Parts (BWP). SL BWP may be sets oof contiguous resource blocks configured for the SL transmissions inside a predetermined channel bandwidth. The configuration of the SL BWP and resource pools is established by the RRC layer and provided to lower layers when activated. There may be at least one active SL BWP for the UE device at a time in a given frequency band. The SL BWP may be defined by its frequency, bandwidth, Subcarrier Spacing (SCS), and Cyclic Prefix (CP). The SL BWP may define parameters common to all the resource pools that are contained within it, namely a number of symbols and starting symbol used for SL in all slots (except those with Synchronization Signal Block (SSB)), power control for PSBCH, and a location of a Direct Current (DC) subcarrier.

The SL BWP may have different lists of resource pools for transmissions and receptions, to allow for the UE device to transmit in a pool and receive in another one. For transmissions, there may be one pool for a selected mode, one for a scheduled mode (e.g., when the gNodeB helps with resource selection), and one for exceptional situations. These resource pools may be expected to be used for only transmission or reception, except when SL feedback mechanisms are activated, in which case the UE device may transmit Acknowledgement (ACK) messages in a reception pool and receive ACK messages in a transmission pool.

In 5G NR technologies, the resource pool may be located inside an SL BWP is defined by a set of contiguous Resource Blocks (RBs) defined by the information element labeled sl-Rb-Number in the frequency domain starting at an RB defined by the information element labeled sl-StartRBsubchannel. Further, the resource pool may be divided into subchannels of a size defined by the information element labeled sl-SubchannelSize, which can take one of multiple values (i.e., 10, 12, 15, 20, 25, 50, 75, and 100). Depending on the value of sl-RB-Number and sl-SubchannelSize, some RBs inside the resource pool may not be used by the UEs.

In the time domain, a resource pool has some available slots configured by various parameters. To determine which slots belong to the pool, a series of criteria may be applied. The slots where SSB is transmitted may not be used. The number and locations of those slots may be based on a predefined configuration. Slots that are not allocated for UL (e.g., in the case of Time Division Multiplexing (TDD)) or do not have all the symbols available (as per SL BWP configuration) may also be excluded from the resource pool. Some slots may be reserved such that a number of remaining slots is a multiple of a bitmap length defined by the labels sl-TimeResource-r16 or Lbitmap, that can range from 10 bits to 160 bits. The reserved slots may be spread throughout a variable number of slots. The bitmap sl-TimeResource-r16 may be applied to the remaining slots to compute a final set of identified/labeled slots that belong to the pool.

In some embodiments, the duration of each SL frame and SL subframe is 10 milliseconds (ms) and 1 ms, respectively. The SL frames and SL subframes may include a numerology u which may define the SCS, a number of slots in a subframe, and cyclic prefix options. In NR SL, the value of u ranges from 0 to 3. In addition, the supported u values vary at different frequency bands. In the frequency domain, the SCS may be defined by the numerology. In this regard, the SCS may be directly proportional to the numerology. Within the SL subframe, slots may be numbered from 0 to N subframe. In NR, given that different UE devices may operate in a different BWP and using a different numerology, a common resource block may be used for a device to locate frequency resources within the carrier bandwidth.

### Example Communication Device

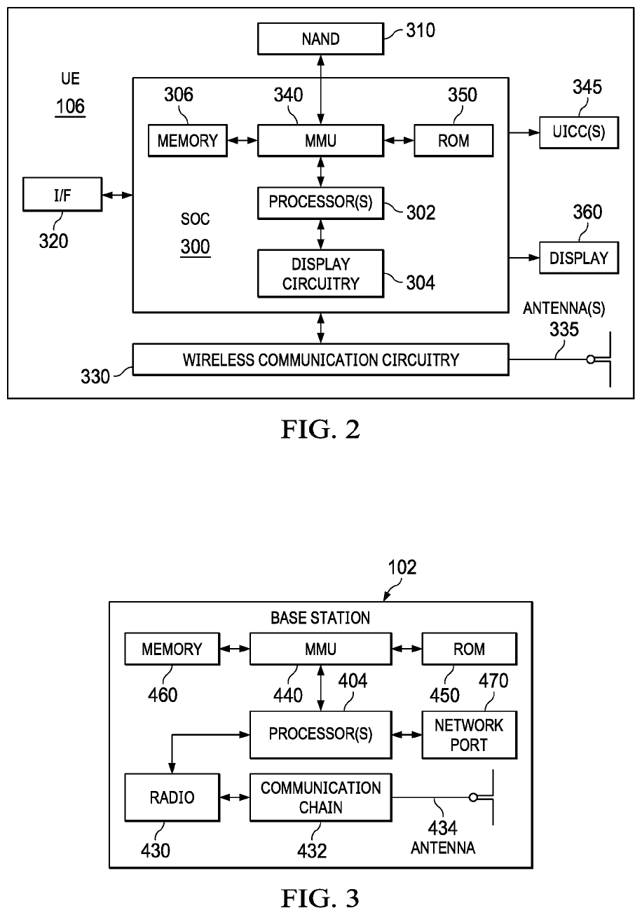

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

FIG. 3 illustrates an example block diagram of a base station 102, according to some aspects. It is noted that the base station of FIG. 3 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Example Cellular Communication Circuitry

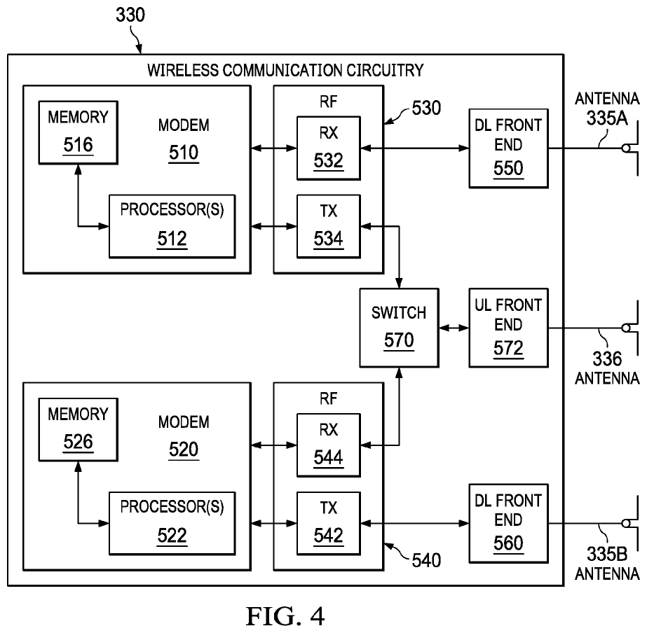

FIG. 4 illustrates an example simplified block diagram of cellular communication circuitry, according to some aspects. It is noted that the block diagram of the cellular communication circuitry of FIG. 4 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 330 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a, 335b, and 336 as shown. In some aspects, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 4, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, and the like) configured to perform the functions of processors 512, 522.

In some aspects, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some aspects, the cellular communication circuitry 330 may also not include the switch 570, and the RF front end 530 or the RF front end 540 may be in communication, e.g., directly, with the UL front end 572.

### Example SL Communication Link Management

SL communication links may be used to help reduce interference and to help support a large number of wireless devices that are neighboring one another. The SL communication links effectively allows transmission and reception of SL transmissions. In some embodiments, the beams are representations of communication being shared between two wireless devices. These SL transmissions may be directed by each wireless device. In some embodiments, the SL transmissions with a predetermined direction may be referred to as beams. As the beams are directed toward a relatively small area as compared to a cell wide signal, a wireless node needs to know where a wireless device is located relative to the wireless node to allow the wireless node to direct beams toward the wireless device.

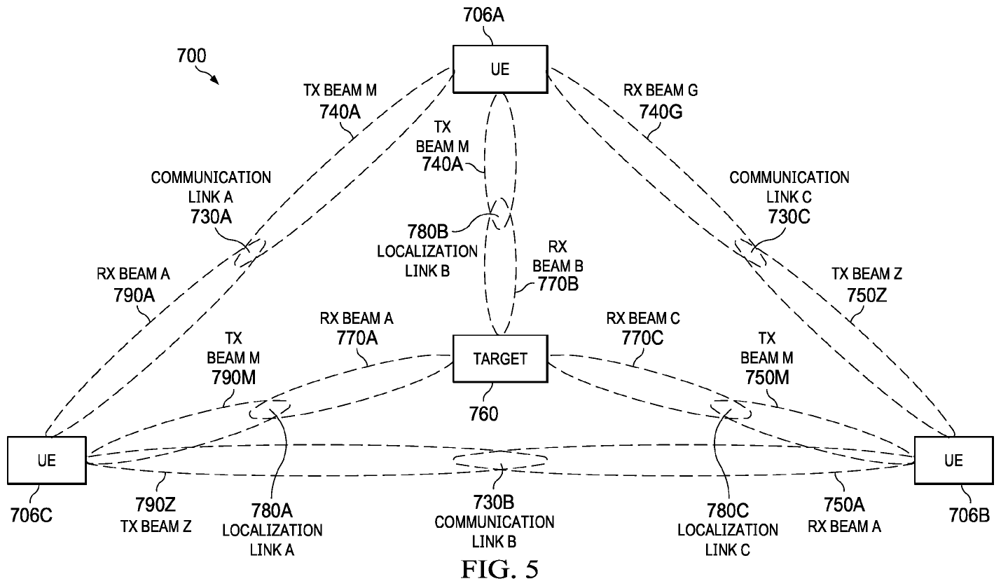

FIG. 5 shows a diagram 500 illustrating multiple SL communication links established to perform multiple SL transmissions. The SL transmissions may be used to implement an SL localization procedure with the goal of obtaining positioning information for a target 760. FIG. 5 shows wireless elements with multi-cell interference equipped with array antennas and capable of establishing multiple SL communication links. The arrays in these wireless elements may be used both for sensing and high-rate low-latency communication.

In the diagram 700 of FIG. 5, the target 760 may request to identify its location using the SL transmissions in coordination with the UE 706A, the UE 706B and the UE 706C. As described above, the SL transmissions may be coordinated to include a resource allocation pattern configured for SL transmissions.

In this example, the UE 706C may include beams A 790A . . . 790Z (collectively 790) configured to exchange SL transmissions. The target 760 may be a wireless device or terminal, such as a UE device with an unknown location. In one or more embodiments, the target 760 may request permissions for exchanging SL transmission with the UE 706A, the UE 706B, and UE 706C. The permissions may be acknowledged through SL transmissions. In this case, the permissions may be required to confirm that resource allocation patterns are being coordinated among multiple SL transmissions. For example, to transmit the SL transmission in a licensed band, the terminal may need to confirm with a base station connected to the network that the licensed band has the space to perform the SL transmission using the requested resource allocation pattern. Similarly, to transmit the SL transmission in the licensed band, the terminal may need to confirm with the base station connected to the network that the power level of the SL transmission is at or below permitted safety/interference thresholds.

In some embodiments, the UE 706C may selectively use certain beams for receiving or transmitting SL transmissions. In the example shown in FIG. 5, the UE 706C may use the transmit beam A 790A and transmit beam Z 790Z for transmitting SL transmissions. The UE 706C may use the receive beam M 790M for receiving SL transmissions. The UE 706C may establish communication link A 730A and communication link B 730B with the UE 706A and the UE 706B, respectively. These communication links may be used by the UE 706C to exchange instructions with the UE 706A and the UE 706B for identifying the location of the target 760. In each communication link, the UE 706A and the UE 706B may provide information to the UE 706C regarding sensing feedback to obtain the positioning information. In this regard, the UE 706A uses transmit beam A 740A and transmit beam M 740M to provide SL transmissions to the UE 706C and the target 760, respectively. The UE 706A may use the receive beam G 840G for receiving SL transmissions from the UE 706B. The UE 706A may establish the communication link A 730A and a communication link C 730C with the UE 706C and the UE 706B, respectively. Finally, the UE 706B uses transmit beam M 750M and transmit beam Z 750Z to provide SL transmissions to the target 760 and the UE 706A, respectively. The UE 706B may use the receive beam A 750A for receiving SL transmissions from the UE 706C. The UE 706B may establish the communication link B 730B and the communication link C 730C with the UE 706C and the UE 706B, respectively.

In the example of FIG. 5, the target 760 uses transmit beam A 770A to provide SL transmissions to the UE 706C. Further, the target 760 uses receive beam B 770B and receive beam C 770C to receive SL transmissions from the UE 706A and the UE 706B. The target 760 may establish a localization link A 780A, a localization link B 780B, and a localization link C 780C with the UE 706C, the UE 706A, and the UE 706B. These localization links may be used by the UE 706C, the UE 706A, and the UE 706B to sense (e.g., identifying) the relative positioning information of the target 760.

In some embodiments, a terminal (e.g., the target 760 described in reference to FIG. 5) performing SL transmissions may be configured to allocate sensing resources in communications with one or more neighboring terminals. The terminal may allocate the resources for the SL transmission based on a terminal capability (i.e., parameters such as UE-Capability) preconfigured in the target 760 and/or based on a terminal capability provided from a higher layer signaling obtained from a device connected directly to a network (i.e., a network gateway or a base station if the terminal is a UE device). In some embodiments, the terminal confirms a resource allocation pattern with another terminal expected to receive the SL transmission before the transmission is performed. The terminal capability may indicate resource allocation support information for the terminal.

In one or more embodiments, the terminal performs the SL transmission to perform an SL localization procedure to obtain positioning information relating to the terminal. The terminal or one of the neighboring terminals may use the SL transmissions to identify or request relative positioning information of a target device. The relative positioning information may include a location and/or a distance of the target device with respect to one of the neighboring terminals. The relative positioning information may include the known locations (e.g., absolute locations) of one or more neighboring terminals. For example, relative positioning information may be obtained by the target device and may include a location of the target device with respect to three different neighboring terminals. The information may also include an absolute location for at least one of the neighboring terminals. Upon receiving the relative positioning information, the target device may calculate its exact location (e.g., a two-dimensional position or a three-dimensional position) with respect to one of the neighboring signals that provided an absolute location. Then, the target device may calculate its absolute location based on the absolute location of the neighboring terminal and the location of the target device with respect to the neighboring terminal.

In one or more embodiments, two UE devices communicating with one another may exchange SL transmissions using the SL communication link. The SL communication link may be defined for 5G NR in section 6.3.8 TS 36.331 of the 3GPP standard.

In some embodiments, a base station performing the functionality and having the structure described in reference to the base station 102 of FIGS. 1 and 3 may be used to calculate the positioning information instead of one of the UE devices.

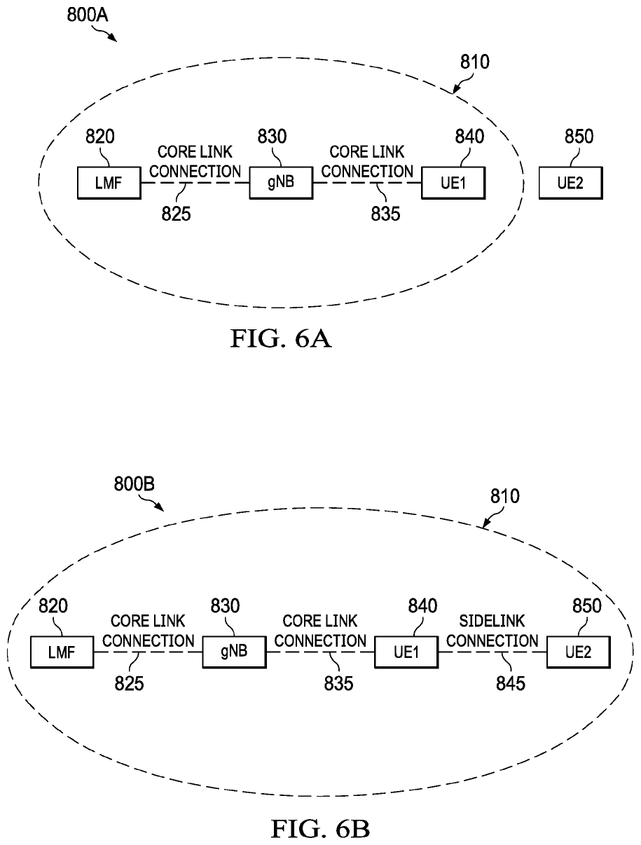

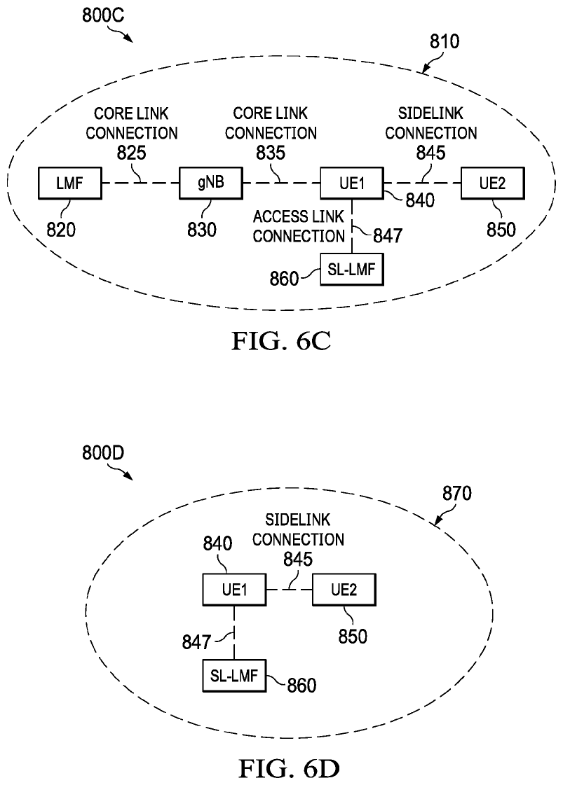

FIGS. 6A to 6D are diagrams illustrating a localization procedure in which positioning information of a terminal is obtained. In FIG. 6A, a system 800A includes a UE2 850 having an unknown location. The UE2 850 is out of an area of coverage 810 provided by a core network (only shown as the area of coverage 810). Thus, the UE2 850 cannot rely on wireless communication services with the core network to obtain its location (e.g., this terminal cannot connect into a localization system, such as GPS or satellite). In the area of coverage 810, a UE1 840 is connected to a gNB 830 that facilitates a connection between the UE1 840 and a Localization Management Function (LMF) 820 via a core link connection 825 and a core link connection 835, respectively. The gNB 830 may perform the functionality of the base station 102 described in reference to FIGS. 1, 3, 4, and 5. The core link connection 835 may be programmed with multiple uplink and downlink transmission channels. The core link connection 845 may be programmed to distribute higher layer signals to other base stations.

In one or more embodiments, the LMF 820 may be configured to provide location services to the UE1 840 in the area of coverage 810. The LMF 820 may receive location services requests from the gNB 830 after receiving a communication request from the UE1 840. In response, the LMF 820 may assist the UE1 840 to identify its location. The location of the UE1 840 may be calculated using only the UE1 840, with the assistance of the gNB 830, or with the assistance of one or more additional neighboring terminals. The LMF 820 may return results of the location service back to the UE1 840 via the gNB 830 (e.g., a position estimate for an absolute location of the UE1 840).

In FIG. 6B, a system 800B includes the UE2 850 having an unknown location. While the UE2 850 may be in the area of coverage 810 provided by the core network, the UE2 850 relies on a sidelink connection 845 with the UE1 840 to reach resources from the core network. Thus, the UE2 850 may rely on wireless communication services with the core network to obtain its location as long as the core network is accessed via the UE1 840. In the area of coverage 810, the UE1 840 is connected to the gNB 830 that facilitates the connection between the UE1 840 and the LMF 820 via the core link connection 825 and the core link connection 835, respectively.

In one or more embodiments, the LMF 820 may be configured to provide location services to the UE1 840 in the area of coverage 810. The LMF 820 may receive location services requests from the gNB 830 after receiving a communication request from the UE1 840 or the UE2 850. In response, the LMF 820 may assist the UE1 840 or the UE2 850 to identify their location. The location of the UE1 840 may be determined as described in reference to FIG. 6A. The location of the UE2 850 may be calculated using the UE1 840, the UE2 850, with the assistance of the gNB 830, or with the assistance of one or more additional neighboring terminals. The LMF 820 may return results of the location service back to the UE2 850 via the sidelink connection 845 with the UE1 840 (e.g., a position estimate for an absolute location of the UE2 850).

In FIG. 6C, a system 800C includes the UE2 850 having an unknown location. While the UE2 850 may be in the area of coverage 810 provided by the core network, the UE2 850 relies on a sidelink connection 845 with the UE1 840 to reach resources from the core network. Thus, the UE2 850 may rely on wireless communication services with the core network to obtain its location as long as the core network is accessed via the UE1 840. In the area of coverage 810, the UE1 840 is connected to the gNB 830 that facilitates the connection between the UE1 840 and the LMF 820 via the core link connection 825 and the core link connection 835, respectively. Additionally, the UE1 840 is in direct communication with an SL-LMF 860 that provides all the functionality described in reference to the LMF 820. The SL-LMF may be a module located in the UE1 840.

In one or more embodiments, the LMF 820 and the SL-LMF 860 may be configured to provide location services to the UE1 840 in the area of coverage 810. The LMF 820 may receive location services requests and provide assistance in the manner described in reference to FIG. 6B.

The SL-LMF 860 may receive location services requests without involving the gNB 830. Instead, the SL-LMF 860 may receive location services requests directly from the UE1 840 via an access link connection 847. In response, the SL-LMF 860 may assist the UE1 840 to identify its location. The location of the UE1 840 may be calculated using the UE1 840, the UE2 850, with the assistance of the gNB 830, or with the assistance of one or more neighboring terminals. The SL-LMF 860 may return results of the location service back directly to the UE1 840.

In one or more embodiments, the SL-LMF 860 may be configured to provide location services to the UE1 840 in the area of coverage 810. The LMF 820 may receive location services requests directly from the UE1 840 after receiving a communication request from the UE2 850. In response, the SL-LMF 860 may assist the UE2 850 to identify its location. The location of the UE2 850 may be determined using the UE1 840, with the assistance of the gNB 830, or with the assistance of one or more additional neighboring terminals. The LMF 820 may return results of the location service back to the UE2 850 via the sidelink connection 845 with the UE1 840.

In FIG. 6D, a system 800D includes the UE2 850 having an unknown location. The UE1 840 and the UE2 850 may be out of coverage from the area of coverage 810. Instead, the UE1 840 and the UE2 850 may be in an area of coverage 870 provided by the UE1 840 and its connection to the SL-LMF 860 via the access link connection 847. The area of coverage 870 may be provided by a network with localization capabilities other than the core network. The area of coverage 870 may be provided by the core network via the SL-LMF.

In one or more embodiments, SL-LMF 860 may be configured to provide location services to the UE1 840 and the UE2 850 in the area of coverage 870. The SL-LMF 860 may receive location services requests and provide assistance in the manner described in reference to FIG. 6C.

In localization procedures involving the SL-LMF 860; the UE1 840 or the UE2 850 may identify that the UE2 850 is not capable of receiving downlink communication signals from the core network due to terminal capabilities or terminal configurations associated with the UE2 850. To obtain relative positioning information for the UE2 850; the UE2 850 may determine a resource allocation pattern in accordance with the SL-LMF located in the UE1 840. The UE2 850 may be configured to exchange SL transmissions with the UE1 840 via the sidelink connection 845. The sidelink connection 845 may be an SL communication link established using synchronization information in the manner described in reference to FIG. 5.

The SL communication link may be established using reference information. The reference information may include communication information identifying at least one neighboring terminal to UE2 850 as a positioning reference. The positioning reference may be a neighboring terminal that is configured to obtain its absolute location on Earth or on the specific area. In the examples of FIGS. 6A-6D, the positioning reference may be the UE1 840.

In some embodiments, the SL-LMF 860 identifies the relative positioning information for the UE2 850 without calculating its absolute location. In these cases, the relative positioning information may include a location of the UE2 850 with respect to the UE1 840 and an absolute location of the UE1 840. The UE1 840 or the UE2 850 may calculate an absolute location of the UE2 850 based on the relative positioning information.

The configuration parameters used to implement the SL localization procedure may the received at the UE1 840 and/or the UE2 850 from the SL-LMF 860. Further, the absolute location of the UE1 840 and/or the absolute location of the UE2 850 may be calculated by the SL-LMF 860, which does not require the UE devices to perform any calculations.

### SL Transmissions in LMF_{Localization} Procedures

In one or more embodiments, information may be transferred from a UE device to one of the LMFs. This information may include reference information such as a Secondary Synchronization Reference Signal Received Power (SS-RSRP), a Secondary Synchronization Reference Signal Received Quality (SS-RSRQ), a CSI-RSPR, a CSI-RSRQ, a physical cell ID or other NR Cell/Group Global Identifier, an S-SSB-RSRP, an S-SSB-RSRQ, an SL-CSI-RSRP, and/or an SL-CSI-RSRQ. The information may include an SL-UE ID (i.e., ID for a terminal in SL link communication) and an SL-UE Rx-Tx Time Difference from each UE device. These signals have been described in detail above.

In one or more embodiments, information may be transferred from a reference UE device to one of the LMFs. This information may include SL information such as an SL AoA/AOD (e.g., azimuth and elevation) and a UE ID. The information may include results that may be obtained in NR measurements or Evolved Universal Terrestrial Radio Access (E-UTRA) measurements. The NR measurements may include an SL-UE ID, an S-SSB-RSRP, an S-SSB-RSRQ, an SL-CSI-RSRP, and/or an SL-CSI-RSRQ. The E-UTRA measurements may include an E-UTRA Physical Cell ID, an E-UTRA RSRP, and/or an E-UTRA RSRQ.

### Performing an SL-Group ID Localization Procedure

In one or more embodiments, in an SL-Group ID localization procedure, positioning information regarding a UE device may be estimated after obtaining information regarding a serving gNB and/or a group of neighboring terminals. The SL-Group ID localization procedure may be implemented to determine the location of the first terminal using Group ID information belonging to a group of neighboring terminals. The information may be obtained using SL transmissions in one or more SL communication link. The SL-Group ID may not require the UE device to make additional measurements for the sole purpose of obtaining the positioning information. The localization procedure may not supply a measurement configuration or measurement control message, and the UE device may report the measurements that it has available rather than being required to take additional measurement actions.

The SL-Group ID localization procedure may use UE and/or NR radio resource related measurements to improve a location estimate of the UE device. The information exchanged during SL-Group ID localization procedures may be the same to those listed with respect to SL transmissions in LMF localization procedures.

In the S-SSB-RSRP measurement, the PSBCH DMR may be used to perform an S-SSB-RSRP measurement. Further, the SSSS may be used for the S-SSB-RSRP measurement. The terminal may implement a use of the PSBCH DMRS only or a combination of the SSSS and the PSBCH DMRS.

In the S-SSB-RSRQ, an NxS-SS-RSRP/NR is the carrier Received Signal Strength Indicator (RSSI), where N is the number of resource blocks in the NR carrier RSSI measurement bandwidth.

In the SL-CSI-RS-RSRP measurements and the SL-CSI-RS-RSRQ measurements, the SL-CSI-RSRP may be defined as a linear average over the power contributions (in Watts) of the resource elements of the antenna port(s) that carry CSI reference signals configured for RSRP measurements within the considered measurement frequency bandwidth in the configured CSI-RS occasions. Further, the SL-CSI-RSRQ may be defined as a ratio of the NxCSI-RSRP to CSI-RSSI, where N is the number of resource blocks in the CSI-RSSI measurement bandwidth. The measurements in the numerator and denominator may be made over the same set of resource blocks.

In the Rx-Tx Difference measurements for various UE devices, the results may be obtained via Timing Advance (TA) estimates. In the Sidelink AoA/AOD measurements, results may be estimated at a terminal communicating using an SL communication link based on its capacity (e.g., using algorithms such as MUltiple SIgnal Classification (MUSIC) and Estimation of Signal Parameters via Rotational Invariance Techniques (ESPRIT). These algorithms are non-limiting examples for estimating the azimuth and/or elevation based on identifying a corresponding beam index.

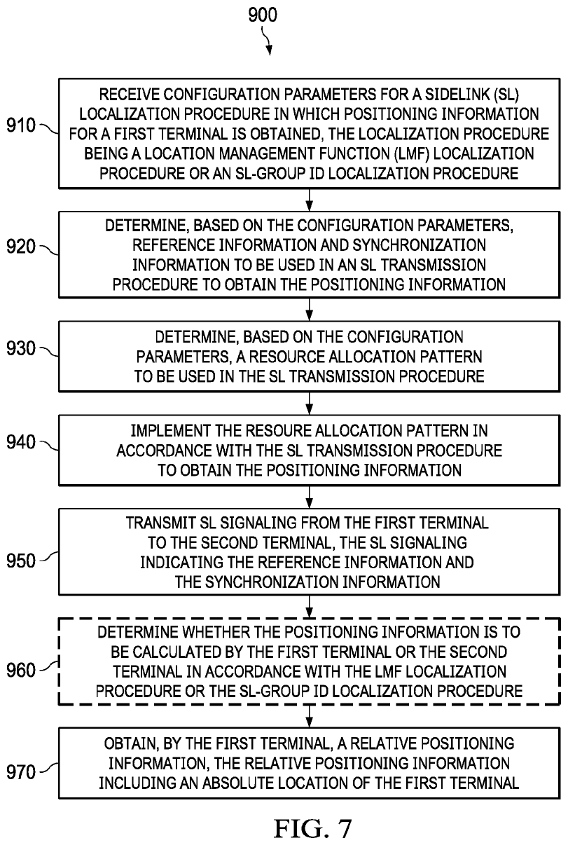

Turning to FIG. 7, a flowchart 900 is shown, detailing a method of performing an SL localization procedure in accordance with an SL-LMF localization procedure or an SL-Group ID localization procedure. In this example, the method is executed by a first terminal exchanging information via SL communication links established with a base station and/or one or more neighboring terminals.

At 910, the flowchart begins with the first terminal receiving, from a second terminal, configuration parameters for an SL localization procedure in which positioning information is obtained. The localization procedure may be an LMF localization procedure or an SL-Group ID localization procedure. The LMF localization procedure may include using an LMF or an SL-LMF to determine the location of the first terminal in the manner described above with respect to FIGS. 6A-6D. The SL-Group ID localization procedure may be implemented to determine the location of the first terminal using Group ID information belonging to a group of neighboring terminals as described above.

At 920, the flowchart continues with the first terminal determining, based on the configuration parameters, reference information and synchronization information to be used in an SL transmission procedure to obtain the positioning information. The reference information may include communication information identifying at least one neighboring terminal to the first terminal as a positioning reference. The positioning reference may be a neighboring terminal that is configured to obtain its absolute location on Earth or on a specific area. The first terminal may implement the SL localization procedure upon receiving instructions from one of its neighboring terminals. The synchronization information may include communication information relating to allocation of resources for at least one synchronization signal. The terminals involved in an SL localization procedure using the SL transmissions may all share the same synchronization signal.

At 930, a resource allocation pattern to be used in the SL transmission procedure is determined based on the configuration parameters. At this stage, for LMF localization procedures, the first terminal or the second terminal may determine whether the first terminal is out of an area of coverage, partially out of the area of coverage, or completely inside the area of coverage. In the SL-Group ID localization procedures, the first terminal or the second terminal may request a group ID and additional group information relating to one or more additional neighboring signals communicating via SL communication links.

At 940, the resource allocation pattern is implemented in accordance with the SL transmission procedure to obtain the positioning information. For LMF localization procedures, the resource allocation pattern is determined based on whether the first terminal is out of an area of coverage, partially out of the area of coverage, or completely inside the area of coverage. For the SL-Group ID localization procedures, the resource allocation pattern is determined based on the group ID and the capability of the neighboring terminals.

At 950, SL signaling is transmitted from the first terminal to the second terminal. The SL signaling may indicate the reference information and the synchronization information. At 960, it is determined whether the positioning information is to be calculated by the first terminal or the second terminal in accordance with the LMF localization procedure or the SL-Group ID localization procedure. At this stage, either terminal may be designated to be the one that calculated the absolute location for the first terminal based on a known location of the positioning reference and the location from the terminal acting as the positioning reference and the first terminal. The positioning reference may be the second terminal, or it may be an additional terminal.

The flowchart ends at 970 with the first terminal obtaining a relative positioning information including an absolute location of the first terminal. Based on the determination in 960, the first terminal or the second terminal determine the absolute location of the first terminal. If the second terminal determines the absolute location of the first terminal, the first terminal obtains this information by receiving a communication from the second terminal.

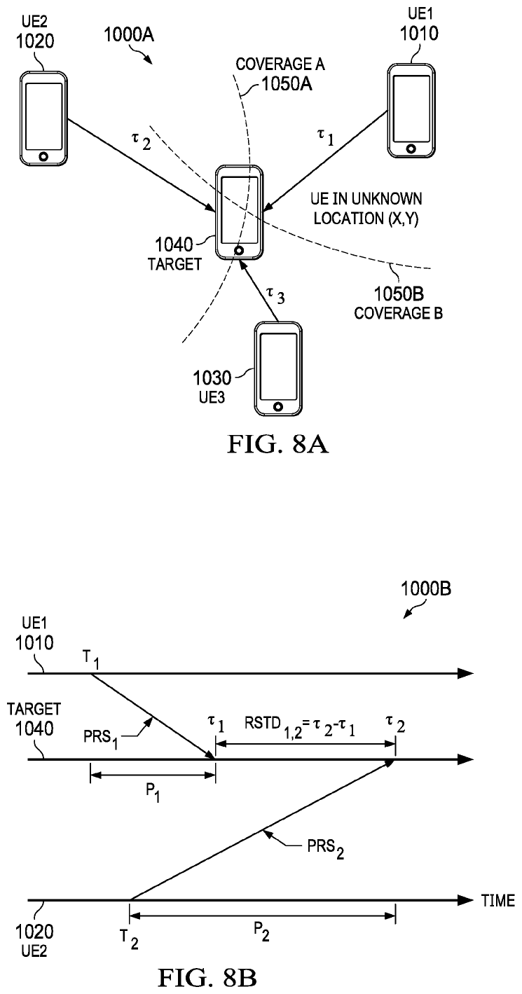

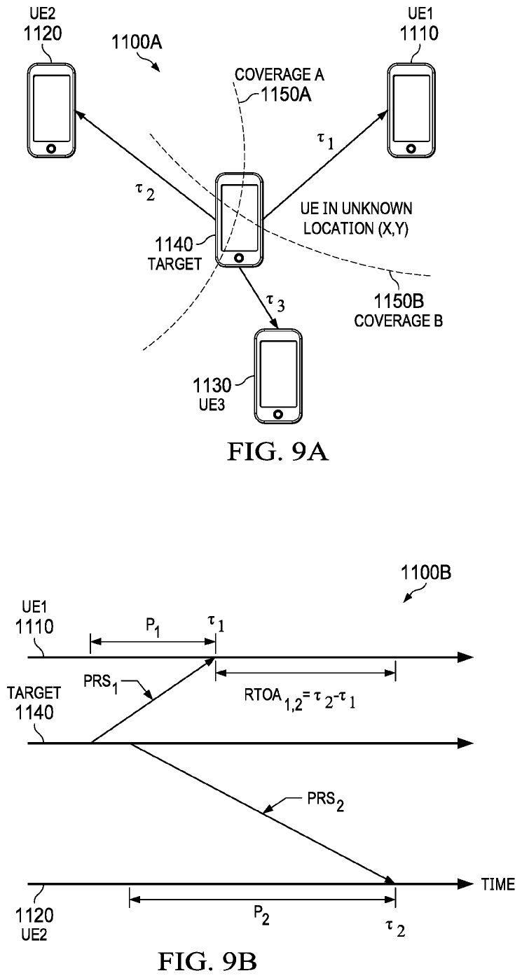

FIGS. 8A and 9A show diagrams 1000A and 1100A respectively illustrating examples of a TDOA localization procedure in accordance with one or more aspects. FIGS. 8A and 9A show wireless elements with multi-cell interference equipped with array antennas and capable of establishing SL communication links and/or to perform SL transmissions. The arrays in these wireless elements may be used both for sensing and high-rate low-latency communication. FIGS. 8B and 9B illustrate timelines for calculating a time of arrival of at least two SL transmissions from the perspective of one of the wireless devices involved in FIGS. 8A and 9A, respectively.

In some embodiments, TDOA localization procedures are based on a time delay of arrival to (or from) a target terminal based on 2 or more neighboring terminals in a positioning set. The positioning set is a group of terminals used to perform SL-TDOA (excluding the target terminal). The positioning set may be preconfigured before the TDOA localization procedure starts or it may be set dynamically. The positioning set may include two terminals for two-dimensional (2-D) positioning and three terminals for 3-D positioning. The TDOA localization procedure may be suitable to identify positioning information relating to target terminals that are out of coverage, in partial coverage, and in complete coverage scenarios.

In one or more embodiments, the TDOA localization procedures solves a system of hyperbolas to estimate the target terminal position using known locations from neighboring terminals in the positioning set. The target terminal may determine a time difference between multiple transmissions received and uses the time information determined to replace unknowns in corresponding equations for each terminal in the positioning set. In FIGS. 8A and 9A, the hyperbolas are form by the multiple areas of coverage represented by dotted lines (only two shown as representative). The neighboring terminals may know their absolute location or be able to obtain their absolute location. In some embodiments, in hybrid SL-TDOA, a gNB may replace one or more of the terminals in the positioning set.

In the TDOA localization procedures, reference information may be transmitted based on whether a transmission is expected to or from the gNB. If a transmission is transmitted to the gNB, then the SL-PSRS may be used as a reference signal. If a transmission is transmitted from the gNB, the target terminal may expect to receive a Uu-based PRS as the reference signal. These procedures may be used in situations where the target terminal is in out of coverage, partial coverage and in full coverage scenarios. The reference information may be preconfigured or dynamically set. The reference information may be set explicitly to obtain positioning information, or it may be different from reference information used for SL transmissions. In the TDOA localization procedures, the synchronization information may indicate that a synchronization source may be used for SL transmissions between neighboring terminals. As described above, the synchronization source may be the same for all terminals in the positioning set. The synchronization source may be a synchronization signal that is preconfigured or dynamically set.

In NR V2X, multiple synchronization sources may be used to meet synchronization source requirements set in TS 38.133 of the 3GPP standard. These synchronization sources may include a GNSS, an NR Cell on a non-V2X source, an E-UTRAN Cell, or a SyncRef UE in out of coverage scenarios. The target terminal may select a synchronization source based on different priorities of the gNB (in cases where the gNB is involved), GNSS, and SyncRef UE.

As described above, a positioning reference may be determined based on the reference information. In some embodiments, the positioning reference is the terminal (i.e., UE device or base station) that serves as reference for the SL-TDOA (possibly with known position such as a positioning reference unit). In this regard, the positioning reference may be a gNB, a UE device/Position Reference Unit that is connected/synchronized to/with a gNB, or any other UE device. The positioning reference may be in coverage of a GNSS (including out-of-coverage terminals) or may be connected/synchronized to a terminal in coverage of the GNSS.

All terminals in the positioning set may need to synchronize to the positioning reference before the absolute location of the target terminal is estimated. In some embodiments, an SL coverage indicator (indicating if a terminal is in or out of coverage) may be used to identify a type of positioning reference from the examples provided above. A GNSS coverage indicator may also be added. In this case, a priority may be used by the terminals in the positioning set to determine which of the terminals is used as reference (e.g., GNSS>gNB).

The SL-TDOA localization procedures may be “incoming” or “outgoing”. In incoming SL-TDOA localization procedures, the target terminal receives the reference signals from the positioning set. This may allow for passive location estimation in which the target terminal is not the target of the signal transmission from the terminals in the positioning set. In outgoing SL-TDOA localization procedures, the target terminal sends the reference signals to the positioning set. In some embodiments, the SL-TDOA localization procedures described herein may be performed from the perspective of one of the neighboring terminals (e.g., a candidate UE). In this case, the localization procedures may be performed, or observed, from the point of view of a predetermined TRP or gNB.

In the diagram 1000A of FIG. 8A, an absolute location of the target 1040 is unknown. To calculate this absolute location, the target 1040 may rely on positioning information obtained from one or more of a UE1 1010, a UE2 1020, and a UE3 1030. The UE1 1010, the UE2 1020, and the UE3 1030 provide signals to the target 1040 at reception times 11, 12, and 13. While FIG. 8A shows multiple UE devices, a combination of UE devices and base stations may be used to determine the absolute location of the target 1040. In FIG. 8A, the positioning set that includes the UE1 1010, the UE2 1020, and the UE3 1030, with one of the UE devices acting as a positioning reference. In the example of FIG. 8A, the UE1 1010 and the UE2 1020 respectively provide a coverage A 1050 A and a coverage B 1050B to the target 1040.

In the incoming SL-TDOA (e.g., IN-SL-TDOA) localization procedures, the absolute location of the target terminal is estimated based on an SL Reference Signal Time Difference (RSTD). Further, the absolute location of the target terminal may be estimated based on SL PRS-RSRP/SL SRS-PRSRP measurements taken at the terminal of radio signals received from multiple NR SL-UEs or a mix of NR TRPs and NR SL-UEs (e.g., Hybrid IN-SL-TDOA) or, along with knowledge of the geographical coordinates of the terminals and their relative received signal timing. In this disclosure, a P(S)RS parameter or information element refers to a signal including the functionality of PRS, SRS, or a combination of both.

According to some aspects, Table 1 below shows information that may be transferred from an LMF to a terminal in the IN-SL-TDOA localization procedure. The LMF may be a traditional LMF or an SL-LMF as described in FIGS. 6A-6D. In this regard, the SL-LMF may be disconnected from the core network core if the terminal hosting it is out of coverage. In Table 1, is indicated whether certain information may be obtained with the help of a given terminal or based on the terminal itself. The terminal-assisted information is information estimated based on measurements performed by the UE device that the UE provides to a neighboring terminal to perform any corresponding calculations. The terminal-based information is information estimated based on measurements and calculations performed by the UE device.

TABLE 1

| | Terminal- | Terminal- |
|---|---|---|
| Information | assisted | based |
| Physical Cell IDs (PCIs), Global Cell IDs | Yes | No |
| (GCIs), Absolute Radio-Frequency | | |
| Channel Number (ARFCN), and PRS | | |
| IDs of candidate NR TRPs for | | |
| measurement. Source IDs of candidate | | |
| SL-UEs. | | |
| Timing relative to the positioning | Yes | Yes |
| reference device of the candidate | | |
| devices. | | |
| Positioning reference configuration (DL- | Yes | Yes |
| PRS, SL-PRS, SL-PSRS) of candidate | | |
| devices. | | |
| SSB information of the TRPs (the | Yes | Yes |
| time/frequency occupancy of SSBs), S- | | |
| SSB information of SL-UEs. | | |
| Spatial direction information (e.g., | No | Yes |
| azimuth, elevation, and the like) of the | | |
| DL-PRS resources of the TRPs served by | | |
| the gNB. | | |
| Geographical coordinates of the TRPs | No | Yes |
| served by the gNB (include transmission | | |
| reference location for each DL-PSR | | |
| Resource ID, reference location for the | | |
| transmitting antenna of the reference | | |
| TRP, relative locations for transmitting | | |
| antennas of other TRPs). | | |
| Geographical coordinates of candidate | | |
| SL-UEs. | | |
| Fine Timing relative to the serving | No | Yes |
| (reference) device of candidate devices. | | |
| PRS-only TP indicator, DL-P(S)RS-only | Yes | Yes |
| UE indicator. | | |

According to some aspects, Table 2 below shows information that may be transferred from the UE to LMF in IN-SL-TDOA.

TABLE 2

| | Terminal- | Terminal- |
|---|---|---|
| Information | assisted | based |
| Latitude, longitude, and/or Altitude, | No | Yes |
| together with uncertainty shape. | | |
| PCI, GCI, ARFCN, PRS resource ID, | Yes | No |
| resource set ID, and PRS ID for each | | |
| measurement. | | |
| SL-P(S)RS resource ID and SL-P(S)RS | | |
| ID for each measurement. | | |
| DL-RSTD measurement. | Yes | No |
| SL-RSTD measurement. | | |
| DL-PRS-RSRP measurement. | Yes | No |
| SL-PRS-RSRP measurement. | | |
| Time stamp of the measurements. | Yes | No |
| Time stamp of the location estimate. | No | Yes |
| Quality of each measurement | Yes | No |

According to some aspects, Table 3 below shows information that may be transferred from the gNB/SL-UEs to LMF in IN-SL-TDOA.

TABLE 3

Information
PCI, GCI, ARFCN, TRP IDs for the TRPs served by the gNB.
Source IDs of candidate SL-UEs.
Timing information of TRPs served by the gNB.
Timing information of candidate SL-UEs.
Positioning reference configuration (DL-PRS,
SL-PRS, SL-PSRS) of candidate devices.
SSB information of the TRPs (the
time/frequency occupancy of SSBs), S-SSB
information of SL-UEs.
Spatial direction information of the DL-PRS
resources of the TRPs served by the gNB.
Geographical coordinates of the DL-PRS Resources
of the TRPs served by the gNB.
Geographical coordinates information of the
SL-P(S)RS resources of the candidate
SL-UEs.

The IN-SL-TDOA localization procedures may include identifying the positioning set, identifying the positioning reference in the positioning set, establishing a common synchronization reference, configuring an SL-P(S)RS, and configuring the positioning set group (for P(S)RS reception with or without PSSCH). To obtain the positioning information for the target 1040, each terminal in the positioning set may send a corresponding SL-P(S)RS in SL transmissions. To obtain the positioning information, the target 1040 may send an SL-P(S)RS request to the positioning set. In response, the position set sends the SL-P(S)RS. As described above, the SL-P(S)RS may be FDM (SL-PRS or SL-SRS) or CDM (SL-SRS).

Further, the transmissions with the SL-P(S)RS may be periodic or semi-persistent scheduling (SPS). Finally, the transmissions with the SL-P(S)RS may be sent individually from each terminal in the positioning set within a preconfigured or dynamically modified time limit.

After the SL transmissions are received, SL transmissions indicating TDOA feedback may be transmitted to a positioning estimator. The positioning estimator may be a UE positioning estimator implemented using physical layer feedback (e.g., Layer 1 feedback). The feedback may include all the localization information needed to determine the absolute location of the target 1040. The positioning estimator may be a designated UE or gNB from the positioning set. In this case, the feedback may be provided to the designated UE/gNB. The positioning estimator may be an LMF/SL-LMF. In this case, the feedback may be provided to the LMF/SL-LMF. The positioning estimator may be the target 1040, in which case no feedback is needed.

FIG. 8B shows an example of a timeline 1000B representing the arrival of multiple PRSs at the target 1040 from the UE1 1010 and the UE 2 1020, which respectively provide the coverage A 1050 A and the coverage B 1050B to the target 1040. In the example of FIG. 8B, time increases following the direction of the arrows (to the right). At a first transmission time (T₁), the UE1 1010 performs an SL transmission including a first PSR (PSR₁) towards the target 1040. The first PSR arrives to the target 1040 at a first reception time (τ₁). The difference between the first transmission time and the first reception time is a first time displacement (P₁). At a second transmission time (T₂), the UE2 1020 performs an SL transmission including a second PSR (PSR₂) towards the target 1040. The second PSR arrives to the target 1040 at a second reception time (τ₂). The difference between the second transmission time and the second reception time is a second time displacement (P₂). An RSTD of the first reception time and the second reception time is an absolute value of their difference that may be expressed as RSTD_{1,2}=τ₂−τ₁.

If the absolute locations of the UE1 1010 and the UE 2 1020 are known, these locations may be represented as a first location with coordinates (x₁, y₁) and a second location with coordinates (x₂, y₂). Assuming an unknown location with coordinates (x, y) and a speed of light c being equal to about 299,782,458 meters per second, equation pairs based on the first reception time and the second reception time may be derived into equation (1) and (2) as shown below.

$${τ}_{1} = {T}_{1} + {P}_{1} = {T}_{1} + \frac{\sqrt{{( {x}_{1} - x )}^{2} + {( {y}_{1} - y )}^{2}}}{c} \qquad ( 1 )$$

$${τ}_{2} = {T}_{2} + {P}_{2} = {T}_{2} + \frac{\sqrt{{( {x}_{2} - x )}^{2} + {( {y}_{2} - y )}^{2}}}{c} \qquad ( 2 )$$

Equations (1) and (2) may be used to solve for the unknown location with coordinates (x, y). As described above, the target 1040 and/or other terminals in the positioning set may perform these calculations.

In the diagram 1100A of FIG. 9A, an absolute location of the target 1140 is unknown. To calculate this absolute location, the target 1140 may rely on positioning information obtained from one or more of a UE1 1110, a UE2 1120, and a UE3 1130. The UE1 1110, the UE2 1120, and the UE3 1130 provide signals to the target 1140 at reception times 11, 12, and 13. While FIG. 9A shows multiple UE devices, a combination of UE devices and base stations may be used to determine the absolute location of the target 1140. In FIG. 9A, the positioning set that includes the UE1 1110, the UE2 1120, and the UE3 1130, with one of the UE devices acting as a positioning reference. In the example of FIG. 9A, the UE1 1110 and the UE2 1120 respectively provide a coverage A 1150 A and a coverage B 1150B to the target 1140.

In the outgoing SL-TDOA (e.g., OUT-SL-TDOA) localization procedures, the absolute location of the target terminal is estimated based on an SL Relative Time of Arrival (RTOA). Further, the absolute location of the target terminal may be estimated based on SL PRS-RSRP/SL SRS-PRSRP measurements taken at different devices using SL transmissions, along with other configuration information.

According to some aspects, Table 4 below shows information that may be transferred from an LMF to a terminal in the OUT-SL-TDOA localization procedure. The LMF may be a traditional LMF or an SL-LMF as described in FIGS. 6A-6D. In this regard, the SL-LMF may be disconnected from the core network core if the terminal hosting it is out of coverage. In Table 4, is indicated assistance data that may be transferred from a gNB/SL-UE to the LMF.

TABLE 4

Information
PCI, GCI, ARFCN, TRP IDs for the TRPs served by the gNB.
Source IDs of candidate SL-UEs.
SSB information of the TRPs (the time/frequency
occupancy of SSBs), S-SSB information of SL-UEs.
Geographical coordinates of the DL-PRS Resources
of the TRPs served by the gNB.
Geographical coordinates information of
the SL-P(S)RS resources of the candidate
SL-UEs.

According to some aspects, Table 5 shows information that may be transferred from a serving gNB/SL UE to the LMF

TABLE 5

UE Configuration Data
UE SRS configuration.
UE SL-PSRS configuration.
Timing information of the TRP which
configured the UE SRS transmission.
Timing information of candidate SL-UE
which configured the UE P(S)RS
transmission.

According to some aspects, Table 6 shows measurement results that may be transferred from the gNBs/SL-UEs to the LMF.

TABLE 6

Measurement Results
NR Cell Global Identifier (NCGI) and TRP ID of the measurement.
ID of candidate SL-UE.
UL-RTOA
DL-PRS-RSRP
SL-PRS-RSRP
Time stamp of the measurement.
Quality of each measurement.
Beam information of each measurement

The OUT-SL-TDOA localization procedures may include identifying the positioning set, identifying the positioning reference in the positioning set, establishing a common synchronization reference, configuring an SL-P(S)RS, and configuring the positioning set group (for P(S)RS reception with or without PSSCH). To obtain the positioning information for the target 1140, the target 1140 may send a SL-P(S)RS to the positioning set in one or more SL transmissions. To obtain the positioning information, the target 1140 may send an SL-P(S)RSs to the positioning set with a PSSCH. In some cases, the target 1140 may send the PSSCH to one of the terminals in the positioning set and may send the SL-P(S)RSs to all other terminals in the positioning set. Further, the transmissions with the SL-P(S)RS may be periodic or semi-persistent scheduling (SPS). Finally, the transmissions with the SL-P(S)RS may be sent in a groupcast to all the terminals in the positioning set.

After the SL transmissions are received, SL transmissions indicating TDOA feedback may be transmitted to a positioning estimator. The positioning estimator may be a UE positioning estimator implemented using physical layer feedback (e.g., Layer 1 feedback). The feedback may include all the localization information needed to determine the absolute location of the target 1140. The positioning estimator may be a designated UE or gNB from the positioning set. In this case, the feedback may be provided to the designated UE/gNB. The positioning estimator may be an LMF/SL-LMF. In this case, the feedback may be provided to the LMF/SL-LMF. The positioning estimator may be the target 1140, in which case the feedback is transmitted to the target 1140.

FIG. 9B shows an example of a timeline 1100B representing the departure of multiple PRSs from the target 1140 from the UE1 1110 and the UE 2 1120, which respectively provide the coverage A 1150 A and the coverage B 1150B to the target 1140. In the example of FIG. 9B, time increases following the direction of the arrows (to the right). At a broadcast transmission time (T₀), the target 1140 performs SL transmissions including a first PSR (PSR₁) towards the UE1 1110 and a second PSR (PSR₂) towards the UE2 1120. The first PSR arrives to the UE1 1110 at a first reception time (τ₁). The difference between the broadcast transmission time and the first reception time is a first time displacement (P₁). The second PSR arrives to the UE2 1120 at a second reception time (τ₂). The difference between the broadcast transmission time and the second reception time is a second time displacement (P₁). An RSTD of the first reception time and the second reception time is an absolute value of their difference that may be expressed as RSTD_{1,2}=τ₂−τ₁.

If the absolute locations of the UE1 1010 and the UE 2 1020 are known, these locations may be represented as a first location with coordinates (x₁, y₁) and a second location with coordinates (x₂, y₂). Assuming an unknown location with coordinates (x, y) and a speed of light c being equal to about 299,782,458 meters per second, equation pairs based on the first reception time and the second reception time may be derived into equation (3) and (4) as shown below.

$${τ}_{1} = {T}_{0} + {P}_{1} = {T}_{0} + \frac{\sqrt{{( {x}_{1} - x )}^{2} + {( {y}_{1} - y )}^{2}}}{c} \qquad ( 3 )$$

$${τ}_{2} = {T}_{0} + {P}_{2} = {T}_{0} + \frac{\sqrt{{( {x}_{2} - x )}^{2} + {( {y}_{2} - y )}^{2}}}{c} \qquad ( 4 )$$

Equations (1) and (2) may be used to solve for the unknown location with coordinates (x, y). As described above, the target 1140 and/or other terminals in the positioning set may perform these calculations.

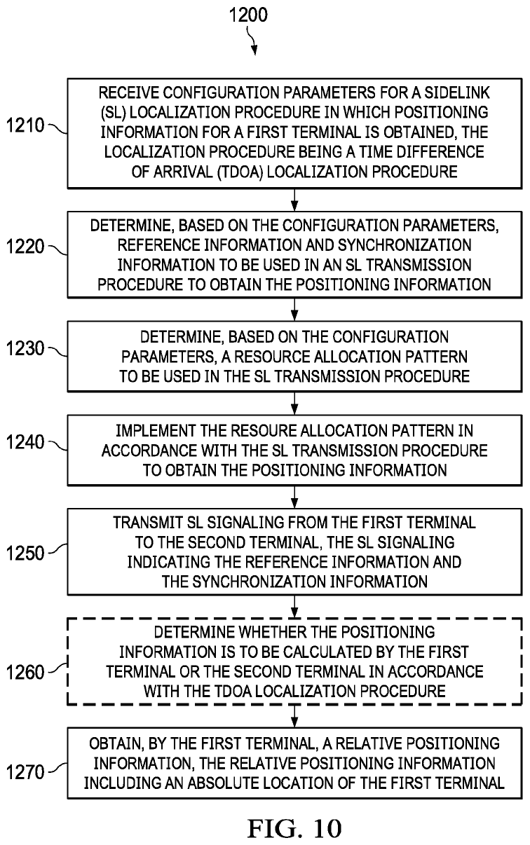

Turning to FIG. 10, a flowchart 1200 is shown, detailing a method of performing an SL localization procedure in accordance with a TDOA localization procedure. In this example, the method is executed by a first terminal exchanging information via SL communication links established with a base station and/or one or more neighboring terminals.

At 1210, the flowchart begins with the first terminal receiving, from a second terminal, configuration parameters for an SL localization procedure in which positioning information is obtained. The localization procedure may be a TDOA localization procedure. The TDOA localization procedure may include using an IN-SL-TDOA or an OUT-SL-TDOA to determine the location of the first terminal in the manner described above with respect to FIGS. 8A and 8B. The IN-SL-TDOA localization procedure may be implemented by prioritizing transferring of SL transmissions to the first terminal. The OUT-SL-TDOA localization procedure may be implemented by prioritizing transferring of SL transmissions from the first terminal.

At 1220, the flowchart continues with the first terminal determining, based on the configuration parameters, reference information and synchronization information to be used in an SL transmission procedure to obtain the positioning information The reference information may include communication information identifying at least one neighboring terminal to the first terminal as a positioning reference. The positioning reference may be a neighboring terminal that is configured to obtain its absolute location on Earth or on a specific area. The first terminal may implement the SL localization procedure upon receiving instructions from one of its neighboring terminals. The synchronization information may include communication information relating to allocation of resources for at least one synchronization signal. The terminals involved in an SL localization procedure using the SL transmissions may all share the same synchronization signal.

At 1230, a resource allocation pattern to be used in the SL transmission procedure is determined based on the configuration parameters. At this stage, for TDOA localization procedures, the first terminal or the second terminal may determine whether the first terminal is out of an area of coverage, partially out of the area of coverage, or completely inside the area of coverage. Further, the first terminal or the second terminal may determine whether the absolute location of the first terminal is to be calculated based on measurements of SL transmissions received by the first terminal or based on SL transmissions transmitted by the first terminal.

At 1240, the resource allocation pattern is implemented in accordance with the SL transmission procedure to obtain the positioning information. For TDOA localization procedures, the resource allocation pattern is determined based on whether the first terminal is out of an area of coverage, partially out of the area of coverage, or completely inside the area of coverage. Further, the resource allocation pattern is determined based on whether assistance data is meant to be provided to an LMF or an SL-LMF. As described above, the LMF and SL-LMF may be incorporated in one of the neighboring terminals in the positioning set.

At 1250, SL signaling is transmitted from the first terminal to the second terminal. The SL signaling may indicate the reference information and the synchronization information. At 1260, it is determined whether the positioning information is to be calculated by the first terminal or the second terminal in accordance with the TDOA localization procedure. At this stage, either terminal may be designated to be the one that calculated the absolute location for the first terminal based on a known location of the positioning reference and the location from the terminal acting as the positioning reference and the first terminal. The positioning reference may be the second terminal, or it may be an additional terminal. Under the TDOA localization procedure, the resource allocation pattern may be implemented to include resources to/from the first terminal that identify the first terminal or the second terminal as a positioning estimator.

The flowchart ends at 1270 with the first terminal obtaining a relative positioning information including an absolute location of the first terminal. Based on the determination in 1260, the first terminal or the second terminal determine the absolute location of the first terminal. If the second terminal determines the absolute location of the first terminal, the first terminal obtains this information by receiving a communication from the second terminal.

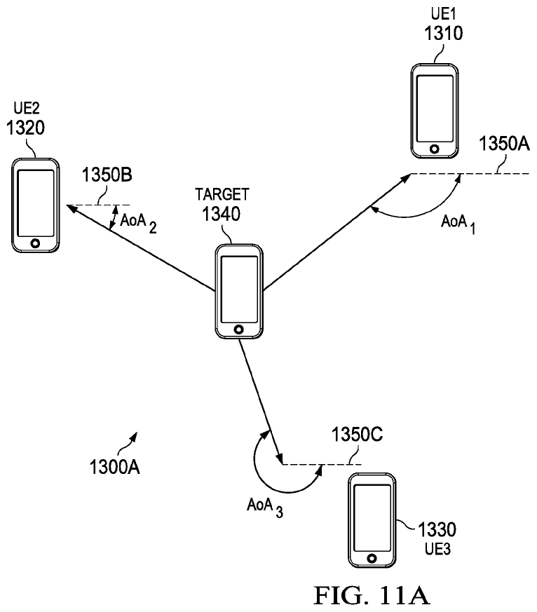

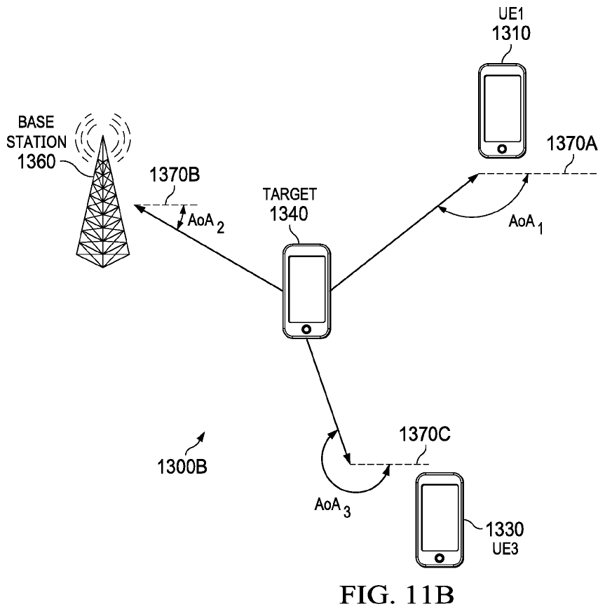

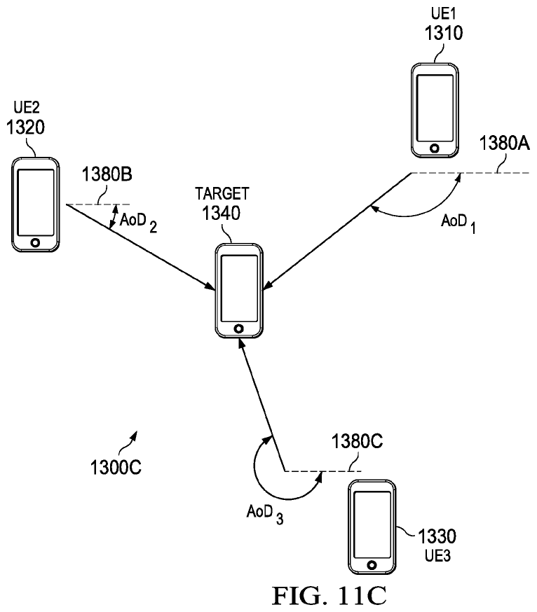

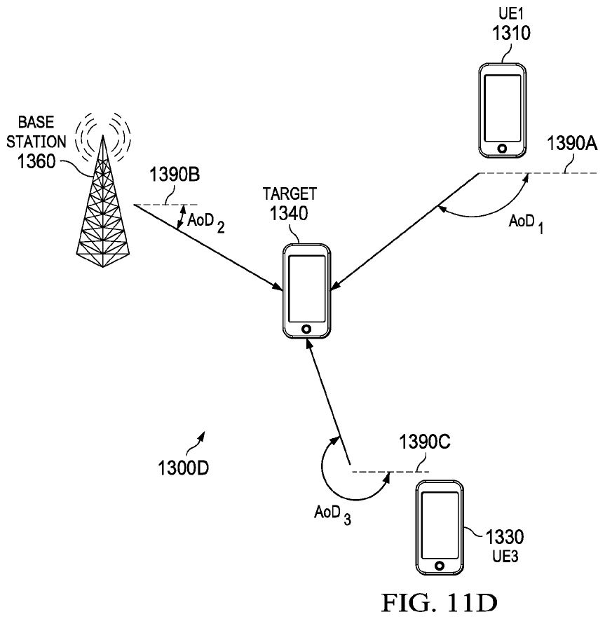

FIGS. 11A-11D illustrate diagrams 1300A-1300D showing multiple terminals configured to identify an absolute location of a target terminal based on 2 or more neighboring terminals in a positioning set. The positioning set is a group of terminals used to perform an AoA localization procedure or an AoD localization procedure (excluding the target terminal). The positioning set may be preconfigured before the localization procedure starts or it may be set dynamically. The absolute location of the target terminal may be determined following the AoA localization procedure or the AoD localization procedure.

In the AoA localization procedure, angles at which SL transmissions arrive to neighboring terminals from the target terminal are measured. These angles are then associated with reference signal measurements for each SL transmission to obtain the absolute location of the target terminal. In the AoD localization procedure, angles at which SL transmissions departure from neighboring terminals to the target terminal are measured. These angles are then associated with reference signal measurements for each SL transmission to obtain the absolute location of the target terminal. The AoA localization procedures and the AoD localization procedures may be configured to obtain the absolute location of the target terminal when the target terminal is out of coverage, is in partial coverage, and in complete coverage scenarios. In the AoA localization procedures and the AoD localization procedures, the azimuth and elevation may be estimated using positioning algorithms, such as the MUSIC or the ESPRIT algorithms. At this point, the position estimator may estimate the absolute location of the target terminal based on a triangulation of the estimated angles. As shown in some of the Figures, a gNB may be one or more of the terminals in positioning set. In cases where the gNB is included, the procedure may be referred to implement hybrid SL positioning operations.

For hybrid SL positioning, positioning information transmitted may be based on whether a transmission is expected to or from the gNB. SL-PSRS may be used by the target terminal in localization procedures involving transmissions to the gNB. In localization procedures involving transmissions from the gNB, the target terminal expects to receive a typical Uu-based PRS.

As described above, a positioning reference may be determined based on the reference information. In some embodiments, the positioning reference is the terminal (i.e., UE device or base station) that serves as reference for the localization procedures (possibly with known position such as a positioning reference unit). In this regard, the positioning reference may be a gNB, a UE device/Position Reference Unit that is connected/synchronized to/with a gNB, or any other UE device. The positioning reference may be in coverage of a GNSS (including out-of-coverage terminals) or may be connected/synchronized to a terminal in coverage of the GNSS.

In AoA localization procedures, the target terminal may send reference signals to all terminals in the positioning set. In AoD localization procedures, the target terminal may receive the reference signals from all terminals in the positioning set. This may allow for passive location estimation in which the target terminal is not the target of the signal transmission from the terminals in the positioning set. In some embodiments, the AoA localization procedures and the AoD localization procedures described herein may be performed from the perspective of one of the neighboring terminals (e.g., a candidate UE). In this case, the localization procedures may be performed, or observed, from the point of view of a predetermined TRP or gNB

In the examples of FIGS. 11A and 11B, multiple terminals attempt to identify an absolute location of a target 1340 in an AoA localization procedure. In FIG. 11A, the rest of the terminals are a positioning set that includes a UE1 1310 receiving signal transmissions at an angle AoA₁ 1350A, a UE2 1320 receiving signal transmissions at an angle AoA₂ 1350A, and the UE3 1330 receiving signal transmissions at an angle AoA₃ 1350A. In FIG. 11B, the rest of the terminals are a positioning set that includes the UE1 1310 receiving signal transmissions at an angle AoA₁ 1370A, a base station 1360 receiving signal transmissions at an angle AoA₂ 1360B, and the UE3 1330 receiving signal transmissions at an angle AoA₃ 1370C. In the AoA localization procedure, the absolute location of the target terminal may be estimated based on SL PRS-RSRP/SL SRS-PRSRP measurements taken at different devices using SL transmissions, along with other configuration information.

According to some aspects, Table 7 below shows information that may be transferred from an LMF to a terminal in the AoA localization procedure. The LMF may be a traditional LMF or an SL-LMF as described in FIGS. 6A-6D. In this regard, the SL-LMF may be disconnected from the core network core if the terminal hosting it is out of coverage. In Table 1, is indicated whether certain information may be obtained with the help of a given terminal or based on the terminal itself.

TABLE 7

Information
PCI, GCI, ARFCN, TRP IDs for the TRPs served by the gNB.
Source IDs of candidate SL-UEs.
SSB information of the TRPs (the time/frequency
occupancy of SSBs), S-SSB information of SL-UEs.
Geographical coordinates of the DL-PRS
Resources of the TRPs served by the gNB.
Geographical coordinates information of the
SL-P(S)RS resources of the candidate
SL-UEs.

According to some aspects, Table 8 shows information that may be transferred from a serving gNB/SL UE to the LMF

TABLE 8

UE Configuration Data
UE SRS configuration.
UE SL-PSRS configuration.
Timing information of the TRP which
configured the UE SRS transmission.
Timing information of candidate
SL-UE which configured the UE P(S)RS
transmission.

According to some aspects, Table 9 shows measurement results that may be transferred from the &NBs/SL-UEs to the LMF.

TABLE 9

Measurement Results
NCGI and TRP ID of the measurement.
ID of candidate SL-UE of the measurement.
UL-AoA (azimuth and elevation).
SL-AoA (azimuth and elevation).
UL-SRS-RSRP
SL-P(S)RS-RSRP
Time stamp of the measurement.
Quality of each measurement.
Beam information of each measurement

The AoA localization procedures may include identifying the positioning set, identifying the positioning reference in the positioning set, configuring an SL-P(S)RS, and configuring the positioning set group (for P(S)RS reception with or without PSSCH). To obtain the positioning information for the target 1340, the target 1340 may send a SL-P(S)RS to the positioning set in one or more SL transmissions. To obtain the positioning information, the target 1340 may send an SL-P(S)RSs to the positioning set with a PSSCH. In some cases, the target 1340 may send the PSSCH to one of the terminals in the positioning set and may send the SL-P(S)RSs to all other terminals in the positioning set. Further, the transmissions with the SL-P(S)RS may be periodic or semi-persistent scheduling (SPS). Finally, the transmissions with the SL-P(S)RS may be sent in a groupcast to all the terminals in the positioning set.

After the SL transmissions are received, the target 1340 measures the AoA and the SL-P(S)RS-RSRP. Further, SL transmissions indicating AoA feedback may be transmitted to a positioning estimator. The positioning estimator may be a UE positioning estimator implemented using physical layer feedback (e.g., Layer 1 feedback). The feedback may include all the localization information needed to determine the absolute location of the target 1340. The positioning estimator may be a designated UE or gNB from the positioning set. In this case, the feedback may be provided to the designated UE/gNB. The positioning estimator may be an LMF/SL-LMF. In this case, the feedback may be provided to the LMF/SL-LMF. The positioning estimator may be the target 1340, in which case the feedback is transmitted to the target 1340.

In the examples of FIGS. 11C and 11D, multiple terminals attempt to identify an absolute location of the target 1340 in an AoD localization procedure. In FIG. 11C, the rest of the terminals are a positioning set that includes the UE1 1310 receiving signal transmissions at an angle AoA₁ 1380A, the UE2 1320 receiving signal transmissions at an angle AoA₂ 1380B, and the UE3 1330 receiving signal transmissions at an angle AoA₃ 1380C. In FIG. 11D, the rest of the terminals are a positioning set that includes the UE1 1310 receiving signal transmissions at an angle AoA₁ 1390A, the base station 1360 receiving signal transmissions at an angle AoA₂ 1390B, and the UE3 1330 receiving signal transmissions at an angle AoA₃ 1390C. In the AoD localization procedure, the absolute location of the target terminal may be estimated based on SL PRS-RSRP/SL SRS-PRSRP measurements taken at different devices using SL transmissions, along with other configuration information.

According to some aspects, Table 7 below shows information that may be transferred from an LMF to a terminal in the AoA localization procedure. The LMF may be a traditional LMF or an SL-LMF as described in FIGS. 6A-6D. In this regard, the SL-LMF may be disconnected from the core network core if the terminal hosting it is out of coverage. In Table 1, is indicated whether certain information may be obtained with the help of a given terminal or based on the terminal itself.

TABLE 10

| | Terminal- | Terminal- |
|---|---|---|
| Information | assisted | based |
| PCIs, GCIs, ARFCN, and PRS IDs of | Yes | Yes |
| candidate NR TRPs for measurement. | | |
| Source IDs of candidate SL-UEs. | | |
| Timing relative to the serving (reference) | Yes | Yes |
| TRP of candidate NR TRPs. | | |
| Timing relative to the reference SL-UE | | |
| of the candidate SL-UEs. | | |
| DL-PRS configuration of candidate NR | Yes | Yes |
| TRPs. | | |
| DL-P(S)RS configuration of candidates | | |
| SL-UEs. | | |
| SSB information of the TRPs (the | Yes | Yes |
| time/frequency occupancy of SSBs). | | |
| S-SSB information of SL-UEs. | | |
| Spatial direction information (e.g., | No | Yes |
| azimuth, elevation, and the like) of the | | |
| DL-PRS resources of the TRPs | | |
| served by the gNB. | | |
| Geographical coordinates of the TRPs | No | Yes |
| served by the gNB (include a | | |
| transmission reference location for each | | |
| DL-PSR Resource ID, reference location | | |
| for the transmitting antenna of the | | |
| reference TRP, relative locations for | | |
| transmitting antennas of other TRPs). | | |
| Geographical coordinates of candidate | | |
| SL-UEs. | | |
| PRS-only TP indicator. | Yes | Yes |
| SL-P(S)RS-only SL-UE indicator. | | |

According to some aspects, Table 11 below shows information that may be transferred from the UE to LMF in IN-SL-TDOA.

TABLE 11

| | Terminal- | Terminal- |
|---|---|---|
| Information | assisted | based |
| Latitude, longitude, and/or Altitude, | No | Yes |
| together with uncertainty shape. | | |
| PCI, GCI, ARFCN, PRS resource set ID, | Yes | No |
| resource set ID, and PRS ID for each | | |
| measurement. | | |
| SL-UE ID, SL-P(S)RS resource ID. SL | | |
| P(S)RS resource set ID, and SL P(S)RS | | |
| ID for each measurement. | | |
| DL-PRS-RSRP measurement. | Yes | No |
| SL-P(S)RS-RSRP measurement. | | |
| Time stamp of the measurements. | Yes | No |
| Time stamp of the location estimate. | No | Yes |
| DS-PRS receive beam index | Yes | No |

According to some aspects, Table 3 below shows information that may be transferred from the gNB/SL-UEs to LMF in IN-SL-TDOA.

TABLE 12

Information
PCI, GCI, ARFCN, TRP IDs for the TRPs served by the gNB.
Source IDs of candidate SL-UEs.
Timing information of TRPs served by the gNB.
Timing information of candidate SL-UEs.
DL-PRS configuration of the TRPs served by the gNB.
DL-P(S)RS configuration of candidates SI-UEs.
SSB information of the TRPs
(the time/frequency occupancy of SSBs).
S-SSB information of SL-UEs.
Spatial direction information of the DL-PRS
resources of the TRPs served by the gNB.
Geographical coordinates information of the
DL-PRS Resources of the TRPs served by the gNB.
Geographical coordinates information of the
SL-P(S)RS resources of the candidate SL-UEs.

The AoD localization procedures may include identifying the positioning set, configuring an SL-P(S)RS, and configuring the positioning set group (for P(S)RS reception with or without PSSCH). To obtain the positioning information for the target 1340, each terminal in the positioning set may send a corresponding SL-P(S)RS in SL transmissions. To obtain the positioning information, the target 1340 may send an SL-P(S)RS request to the positioning set. In response, the position set sends the SL-P(S)RS. As described above, the SL-P(S)RS may be FDM (SL-PRS or SL-SRS) or CDM (SL-SRS). Further, the transmissions with the SL-P(S)RS may be periodic or semi-persistent scheduling (SPS). Finally, the transmissions with the SL-P(S)RS may be sent individually from each terminal in the positioning set within a preconfigured or dynamically modified time limit.

After the SL transmissions are received, the SL transmissions indicating AoD feedback may be transmitted to a positioning estimator. The positioning estimator may be a UE positioning estimator implemented using physical layer feedback (e.g., Layer 1 feedback). The feedback may include all the localization information needed to determine the absolute location of the target 1340. The positioning estimator may be a designated UE or gNB from the positioning set. In this case, the feedback may be provided to the designated UE/gNB. The positioning estimator may be an LMF/SL-LMF. In this case, the feedback may be provided to the LMF/SL-LMF. The positioning estimator may be the target 1340, in which case the feedback does not need to be transmitted.

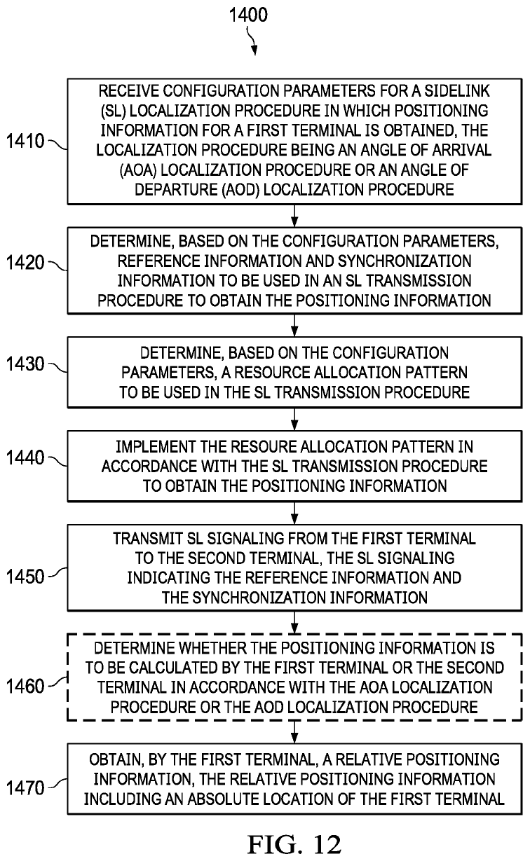

Turning to FIG. 12, a flowchart 1400 is shown, detailing a method of performing an SL localization procedure in accordance with an AoA localization procedure or an AoD localization procedure. In this example, the method is executed by a first terminal exchanging information via SL communication links established with a base station and/or one or more neighboring terminals.

At 1410, the flowchart begins with the first terminal receiving, from a second terminal, configuration parameters for an SL localization procedure in which positioning information is obtained. The localization procedure may be an AoA localization procedure or an AoD localization procedure performed to determine the location of the first terminal in the manner described above with respect to FIGS. 11A-11D. The AoA localization procedure may be implemented by prioritizing transferring of SL transmissions from the first terminal and collecting an angle at which these signals arrive to neighboring terminals. The AoD localization procedure may be implemented by prioritizing transferring of SL transmissions to the first terminal and collecting an angle at which these signals depart from neighboring terminals.

At 1420, the flowchart continues with the first terminal determining, based on the configuration parameters, reference information and synchronization information to be used in an SL transmission procedure to obtain the positioning information. The reference information may include communication information identifying at least one neighboring terminal to the first terminal as a positioning reference. The positioning reference may be a neighboring terminal that is configured to obtain its absolute location on Earth or on a specific area. The first terminal may implement the SL localization procedure upon receiving instructions from one of its neighboring terminals. The synchronization information may include communication information relating to allocation of resources for at least one synchronization signal. The terminals involved in an SL localization procedure using the SL transmissions may all share the same synchronization signal.

At 1430, a resource allocation pattern to be used in the SL transmission procedure is determined based on the configuration parameters. At this stage, for AoA localization procedures and AoD localization procedures, the first terminal or the second terminal may determine whether the first terminal is out of an area of coverage, partially out of the area of coverage, or completely inside the area of coverage. Further, the first terminal or the second terminal may determine whether the absolute location of the first terminal is to be calculated based on SL transmissions transmitted by the first terminal or based on measurements of SL transmissions received by the first terminal.

At 1440, the resource allocation pattern is implemented in accordance with the SL transmission procedure to obtain the positioning information. For AoA localization procedures and AoD localization procedures, the resource allocation pattern is determined based on whether the first terminal is out of an area of coverage, partially out of the area of coverage, or completely inside the area of coverage. Further, the resource allocation pattern is determined based on whether assistance data is meant to be provided to an LMF or an SL-LMF. As described above, the LMF and SL-LMF may be incorporated in one of the neighboring terminals in the positioning set.

At 1450, SL signaling is transmitted from the first terminal to the second terminal. The SL signaling may indicate the reference information and the synchronization information. At 1460, it is determined whether the positioning information is to be calculated by the first terminal or the second terminal in accordance with the AoA localization procedure or the AoD localization procedure. At this stage, either terminal may be designated to be the one that calculated the absolute location for the first terminal based on a known location of the positioning reference and the location from the terminal acting as the positioning reference and the first terminal. The positioning reference may be the second terminal, or it may be an additional terminal. Under the AoA localization procedure or the AoD localization procedure, the resource allocation pattern may be implemented to include resources to/from the first terminal that identify the first terminal or the second terminal as a positioning estimator.

The flowchart ends at 1470 with the first terminal obtaining a relative positioning information including an absolute location of the first terminal. Based on the determination in 1460, the first terminal or the second terminal determine the absolute location of the first terminal. If the second terminal determines the absolute location of the first terminal, the first terminal obtains this information by receiving a communication from the second terminal.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102, a network element 600) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A first terminal, comprising:
a receiver that receives, from a second terminal, configuration parameters for a Sidelink (SL) localization procedure in which positioning information of the first terminal is obtained; and
a processor configured to:
determine, based on the configuration parameters, reference information and synchronization information to be used in a SL transmission procedure to obtain the positioning information.

2. The first terminal of claim 1, wherein the processor is further configured to:
determine, based on the configuration parameters, a resource allocation pattern to be used in the SL transmission procedure, and
implement the resource allocation pattern in accordance with the SL transmission procedure to obtain the positioning information.

3. The first terminal of claim 1, further comprising:
a transmitter that transmits a broadcasting signal to the second terminal, the broadcasting signal including terminal capability and a communication request,
wherein the terminal capability is information regarding one or more transmission and reception capabilities of the first terminal, and
wherein the communication request is signaling requesting a start of the localization procedure.

4. The first terminal of claim 1, wherein the configuration parameters are received by the first terminal via an SL communication link.

5. The first terminal of claim 1, wherein:
the second terminal is a base station, and
the configuration parameters are determined by the base station via higher layer signaling.

6. The first terminal of claim 1, wherein:
the localization procedure is a Localization Management Function (LMF) localization procedure, and
the processor is further configured to:
identify that the first terminal is not capable of receiving downlink communication signals from a core network,
determine the resource allocation pattern in accordance with an SL-LMF located in the second terminal.

7. The first terminal of claim 6, wherein:
the transmitter is further configured to transmit SL signaling to the second terminal, the SL signaling indicating the reference information and the synchronization information, and
the receiver is further configured to receive a relative positioning information including a location of the first terminal with respect to the second terminal and an absolute location of the second terminal, the absolute location of the second terminal being obtained via the SL-LMF, and
the processor is further configured to calculate an absolute location of the first terminal based on the relative positioning information.

8. The first terminal of claim 6, wherein:
the transmitter is further configured to transmit SL signaling to the second terminal, the SL signaling indicating the reference information and the synchronization information, and
the receiver is further configured to receive a relative positioning information including an absolute location of the first terminal, the absolute location of the first terminal being obtained via the SL-LMF in the second terminal.

9. The first terminal of claim 1, wherein:
when the localization procedure is an SL-Group ID localization procedure, and
the processor is further configured to:
identify a SL-Channel State Information (CSI) configuration in the configuration parameters, the SL-CSI configuration supporting a power measurement or a quality measurement in a predetermined frequency bandwidth, and
determine the resource allocation pattern in accordance with the SL-CSI configuration.

10. The first terminal of claim 9, wherein:
the transmitter is further configured to transmit the resource allocation pattern to the second terminal,
the receiver is further configured to receive a relative positioning information from the second terminal, the relative positioning information including a power measurement result or a quality measurement result and a coverage information relating to the second terminal, and
the processor is further configured to calculate an absolute location of the first terminal based on the relative positioning information.

11. The first terminal of claim 1, wherein the processor is further configured to determine the resource allocation pattern in accordance with the reference information and the synchronization information.

12. The first terminal of claim 11, wherein the localization procedure is one of: a Location Management Function (LMF) localization procedure, a Time Difference of Arrival (TDOA) localization procedure, an Angle of Arrival (AoA) localization procedure, an Angle of Departure (AoD) localization procedure, or an SL-Group ID localization procedure.

13. (canceled)

14. The first terminal of claim 11, wherein:
the processor is further configured to:
establish a communication link with a third terminal, and
identify the second terminal or the third terminal as a positioning reference based on the reference information, and
the transmitter is further configured to transmit the reference information and the synchronization information to the second terminal and the third terminal.

15. The first terminal of claim 14, wherein:
the receiver is further configured to receive a relative positioning information from the second terminal or the third terminal, the relative positioning information including an absolute location of the first terminal estimated based on positioning information received by the positioning reference.

16. The first terminal of claim 14, wherein:
the receiver is further configured to receive a relative positioning information from each of the second terminal and the third terminal, each relative positioning information including an absolute location of the second terminal or the third terminal, and a location from the first terminal to the second terminal or the third terminal, and
the processor is further configured to calculate an absolute location of the first terminal based on the absolute location of the second terminal, the absolute location of the third terminal, and the location from the first terminal to the second terminal or the third terminal.

17. The first terminal of claim 11, wherein:
the processor is further configured to:
establish a communication link with a third terminal, and
identify the second terminal or the third terminal as a positioning reference based on the reference information,
the receiver is further configured to receive measurement information from the second terminal and the third terminal, the measurement information being calculated by each of the second terminal and the third terminal based on the reference information and the synchronization information.

18. (canceled)

19. The first terminal of claim 17, wherein:
the processor is further configured to calculate an absolute location of the first terminal based on the measurement information received from the second terminal and the third terminal.

20. A method, comprising:
receiving, at a first terminal from a second terminal, configuration parameters for a Sidelink (SL) localization procedure in which positioning information of the first terminal is obtained; and
determining, based on the configuration parameters, reference information and synchronization information to be used in a SL transmission procedure to obtain the positioning information.

21. (canceled)

22. (canceled)

23. (canceled)

24. (canceled)

25. An integrated circuit configured to cause a first terminal to:
receive, from a second terminal, configuration parameters for a Sidelink (SL) localization procedure in which positioning information of the first terminal is obtained; and
determine, based on the configuration parameters, reference information and synchronization information to be used in a SL transmission procedure to obtain the positioning information.
